(19) United States
(12) Patent Application Publication
(10) Pub. No.: US 2007/0061844 A1
(43) Pub. Date: Mar. 15, 2007

(54) Cellular television broadcast system

(76) Inventors: Shigeaki Hakusui, Boxford, MA (US); Takeo Kanai, Mission Viejo, CA (US)

Correspondence Address: BROMBERG & SUNSTEIN LLP, 125 SUMMER STREET, BOSTON, MA, 02110-1618, US

(21) Appl. No.: 11/442,661

(22) Filed: May 26, 2006

Related U.S. Application Data
(60) Provisional application No. 60/685,242, filed on May 27, 2005.
(60) Provisional application No. 60/786,130, filed on Mar. 27, 2006.

(51) Int. Cl. H04N 7/16; H04N 7/20

(52) U.S. Cl. 725/62; 725/73

(57) ABSTRACT

Information services are provided via an over-the-air television broadcasting system that is segmented into a plurality of cells. Each cell includes one or more transmitting facilities for transmitting service information and mapping information. The mapping information includes adjacent cell information enabling mobile receiver units to transition between cells in order to continue receipt of service information without requiring communication from the receiver unit to the service provider. The transmitting facilities of adjacent cells may operate on the same television channel and/or on different television channels, typically chosen from a frequency set allocated to a given service provider. The service information may include different content in different cells, such as local content specific to each cell. The service information may be provided from one or more content servers in communication with the transmitting facilities.

### PRIORITY

This patent application claims priority from U.S. Provisional Patent Application No. 60/685,242 entitled Cellularized Over-the-Air Multimedia Broadcast System filed on May 27, 2005 in the names of Shigeaki Hakusui and Takeo Kanai and from U.S. Provisional Patent Application No. 60/786,130 entitled CELLULAR TELEVISION BROADCAST SYSTEM filed on Mar. 27, 2006 in the names of Shigeaki Hakusui and Takeo Kanai, both of which are hereby incorporated herein by reference in their entireties.

### FIELD OF THE INVENTION

The present invention relates to delivery of information services, specifically using a cellular over-the-air broadcast television system.

### BACKGROUND

Current over-the-air TV broadcast systems use a single frequency band for a given service operator or a TV program. Therefore, a program recipient selects a TV program or a particular service operator by selecting the particular frequency (referred to hereinafter as a television channel) for the program or operator. This remains true when it comes to digital TV broadcast.

The aforementioned scheme, however, limits the available data (such as digital TV programs) that may be transmitted since the available bandwidth for all the recipients is limited to the bandwidth at which the operator operates. In the NTSC Standard, for example, the bandwidth is 6 MHz. Some television operators, however, have a plurality of frequency bands in case interference is severe and an auxiliary band is needed to overcome the interference. Regardless of the number of frequency bands a certain broadcaster has, broadcasters try reduce the number of transmitters and maximize the coverage area for economical reasons (e.g., high-power transmitting equipment is typically very expensive to own and operate, and a large coverage area attracts large advertisers from which the broadcasters derive significant revenue). Because of the limited bandwidth and single, large coverage area of traditional over-the-air TV broadcasting, over-the-air TV broadcasting is not particularly well suited to high-bandwidth applications (e.g., video-on-demand), and is limited in its ability to deliver location based contents to specific areas.

### SUMMARY OF THE INVENTION

Embodiments of the present invention provide information services via an over-the-air television broadcasting system that is segmented into a plurality of cells. Each cell typically includes one or more transmitting facilities. The transmitting facilities of adjacent cells may operate on the same television channel and/or on different television channels, typically chosen from a frequency set allocated to a given service provider. The coverage areas of different cells can have different effective sizes and shapes depending on, among other things, the placement and power of transmitters. Within each cell, mapping information including adjacent cell information is transmitted. The mapping information allows receiver units to identify, evaluate, and transition between cells without requiring upstream communications from the receiver units back to the service provider.

In accordance with one aspect of the invention there is provided a cellular television broadcasting system including at least one content server for providing service information from a service provider and a plurality of cells. Each cell includes a transmitting facility in communication with at least one content server for transmitting service information and mapping information over at least one over-the-air broadcast television channel. The mapping information includes adjacent cell information enabling a mobile receiver unit to transition from a current cell to an adjacent cell in order to continue receipt of service information without requiring communication from the receiver unit to the service provider.

In accordance with another aspect of the invention there is provided a method for providing an information service in an over-the-air broadcast television system involving transmitting service information from a service provider over at least one over-the-air broadcast television channel in each of a plurality of cells and transmitting mapping information over the at least one over-the-air broadcast television channel in each of the plurality of cells. The mapping information includes adjacent cell information, such as contents identifications of adjacent cells, enabling a mobile receiver unit to transition from a current cell to an adjacent cell in order to continue receipt of service information without requiring communication from the receiver unit to the service provider.

In various alternative embodiments, the mapping information may further include information regarding the current cell and/or information regarding the service information itself. The broadcast television channels may be UHF television channels. Adjacent cells may transmit on the same or on different television channels. The service information may include multimedia information or television content. Different content, such as local content, may be transmitted in different cells. Different content may be logically divided into different content classes, such as local content, regional content, and global content. Transmissions may be segmented such that different segments are used for different content classes, in which case transmissions may utilize a predetermined pattern of segments. Each segment may include a class-of-service indicator.

Additionally, or alternatively, the at least one content server and the transmitting facilities may be coupled over an IP network. Each transmitting facility may be assigned a unique address (such as an IP address for use over an IP network) within the system for communication with the at least one content server. Within a cell, transmissions may be addressed to a plurality of users (e.g., broadcast or multicast) and/or addressed to a single user (e.g., unicast).

Embodiments of the present invention may also enable users to request specific services (e.g., on-demand or interactive services) provided by the cellular television broadcasting system over a separate communication path from the users back to the service provider. Specific content may be provided to a user based on a request received from the user.

Embodiments of the present invention may also monitor qualities of the broadcast television channels and dynamically alter channel assignments based on the monitored qualities.

In accordance with yet another aspect of the invention there is provided apparatus for use in a cellular television broadcast system having a plurality of cells, where each cell transmits service information over at least one over-the-air broadcast television channel. The apparatus includes a receiver for receiving service information and mapping information (including adjacent cell information) over at least one broadcast television channel within a cell and a controller operably coupled to the receiver for transitioning the receiver from at least one broadcast television channel in a current cell to at least one broadcast television channel in an adjacent cell in order to continue receipt of service information without requiring communication back to a service provider.

In various embodiments, the controller may analyze channels in a plurality of cells. The receiver may include at least one television tuner for receiving the service information and mapping information over the at least one broadcast television channel in the current cell and for analyzing the channels. In a single tuner embodiment, the receiver may include a first state in which the service information and mapping information is received over the at least one broadcast television channel in the current cell and a second state in which the channels are analyzed. In alternative embodiments, the receiver may include a first television tuner for receiving the service information and mapping information over the at least one broadcast television channel in the current cell and a second television tuner for analyzing the channels. The receiver channel analysis may include measuring receive signal strength of each channel. The controller may generate a vector for each cell based on the channel analysis. In addition to making roaming decisions, the controller may alternatively or additionally estimate location and/or direction of travel based on the channel analysis. The receiver may utilize positioning information, such as information from a global positioning system (GPS), to generate the vector for appropriate channel selection.

Embodiments of the invention may also include a transmitter operably coupled to the controller for transmitting information to the service provider. The transmitted information may include such things as protocol acknowledgments, requests for on-demand services, requests for interactive services, channel quality information, and positioning information. This information may be transmitted via separate communication path provided by different systems, such as a public telephone network.

### BRIEF DESCRIPTION OF THE DRAWINGS

The foregoing features of the invention will be more readily understood by reference to the following detailed description, taken with reference to the accompanying drawings, in which:

FIG. 1 is a schematic diagram showing a representation of the coverage area of a television system operating with a single television channel as known in the art;

FIG. 2 is a schematic diagram showing a representation of the coverage area of a cellular television system in accordance with an exemplary embodiment of the present invention;

FIG. 3 is a schematic diagram showing a representation of a cellular television system in which adjacent cells utilize different television channels, in accordance with an exemplary embodiment of the present invention;

FIG. 4 is a schematic diagram showing a representation of a cellular television system using a second television channel in one cell, in accordance with an exemplary embodiment of the present invention;

FIG. 5 is a schematic diagram showing a representation of a cellular television system using a second television channel in two adjacent cells, in accordance with an exemplary embodiment of the present invention;

FIG. 6 is a schematic diagram showing a representation of a cellular television system using a separate television channel overlaying the entire coverage area, in accordance with an exemplary embodiment of the present invention;

FIG. 7 is a schematic diagram showing a representation of a cellular television system utilizing three television channels in order to prevent interference among adjacent cells, in accordance with an exemplary embodiment of the present invention;

FIG. 8 is a schematic diagram showing a representation of a cellular television system having different size cells, in accordance with an exemplary embodiment of the present invention;

FIG. 9 is a schematic diagram showing a representation of a cellular television system including geographically defined cells, in accordance with an exemplary embodiment of the present invention;

FIG. 10 is a schematic diagram showing a representation of a cellular television system 100 capable of delivering specific programming to different cells, in accordance with an exemplary embodiment of the present invention;

FIG. 11 is a schematic diagram showing a representation of a system having a global content server and a plurality of local content servers, in accordance with an exemplary embodiment of the present invention;

FIG. 12 is a schematic diagram showing a representation of segmented transmissions, in accordance with an exemplary embodiment of the present invention;

FIG. 13 shows a sequence of transmission segments in accordance with an exemplary embodiment of the present invention;

FIG. 14 is a schematic diagram showing a representation of a cellular television system in which IP packets containing multimedia contents are transmitted to the end-user over the air, in accordance with an exemplary embodiment of the present invention;

FIG. 15 is a schematic diagram showing a representation of a cellular television system with various types of upstream communications, in accordance with an exemplary embodiment of the present invention;

FIG. 16 is a schematic diagram showing a representation of a cellular television system with cellular upstream communications, in accordance with an exemplary embodiment of the present invention;

FIG. 17 is a schematic diagram showing a representation of a cellular television system for mobile communications such as navigation, in accordance with an exemplary embodiment of the present invention;

FIG. 18 is a schematic diagram showing a representation of a cellular television system including upstream communications over an auxiliary IP connection, in accordance with an exemplary embodiment of the present invention;

FIG. 19 is a schematic diagram showing some potential equipment configurations at service provider headend, in accordance with an exemplary embodiment of the present invention;

FIG. 20 is a schematic diagram showing a representation of an asymmetric server, in accordance with an embodiment of the present invention;

FIG. 21 is a schematic diagram showing the relevant components of a receiver unit having a single television tuner, in accordance with an exemplary embodiment of the present invention;

FIG. 22 is a schematic diagram showing the relevant components of a receiver unit having two television tuners, in accordance with an exemplary embodiment of the present invention;

FIG. 23 is a conceptual block diagram showing the relevant components of a receiver unit including upstream communication support, in accordance with an exemplary embodiment of the present invention;

FIG. 24 shows a representation of the layer model for the ISBD-T protocol as known in the art;

FIG. 25 shows a representation of the layer model for a cellular broadcasting protocol in accordance with an exemplary embodiment of the present invention;

FIG. 26 is a logic flow diagram describing method for providing information services in a cellular television system, in accordance with an exemplary embodiment of the present invention;

FIG. 27 is a schematic diagram showing a representation of mapping information transmitted in a cellular television system, in accordance with an exemplary embodiment of the present invention;

FIG. 28 is a schematic diagram showing a representation of channel analysis vectors, in accordance with an exemplary embodiment of the present invention;

FIG. 29 is a schematic diagram showing a representation travel direction estimation, in accordance with an exemplary embodiment of the present invention; and

FIG. 30 is a schematic diagram showing a representation of roaming, in accordance with an exemplary embodiment of the present invention.

### DETAILED DESCRIPTION OF SPECIFIC EMBODIMENTS

Definitions. As used in this description and the accompanying claims, the following terms shall have the meanings indicated, unless the context otherwise requires:

A “mobile receiver unit” is a receiver unit that is capable of moving or being moved among cells of a cellular television system. For example, a mobile receiver unit may be portable or may be installed in a vehicle such as an automobile, motorcycle, boat, etc.

“Mapping information” is information that is transmitted in each cell of a cellular television system in order to enable remote mobile receiver units to operate effectively in a cellular television system. The mapping information typically includes adjacent cell information enabling mobile receiver units to transition between cells without requiring a return communication path from the receiver units to the service provider and without requiring a complex hand-off, as is typically required in cellular telephone systems. The mapping information may also include information about the current cell (such as information regarding topology, power, coverage, CTR location, offset, shape, utilization) as well as information regarding the service information (such as contents identifiers and stream identifiers).

In embodiments of the present invention, information services are provided-via an over-the-air television broadcasting system that is segmented into a plurality of cells. Each cell typically includes one or more transmitting facilities. The transmitting facilities of adjacent cells may operate on the same television channel and/or on different television channels, typically chosen from a frequency set allocated to a given service provider. The coverage areas of different cells can have different effective sizes and shapes depending on, among other things, the placement and power of transmitters.

Within a cell, information may be broadcast, multicast, and/or unicast to one or more users. Embodiments of the present invention can operate over virtually any television channel(s), although specific embodiments may utilize vacant UHF television channels within a given service area. Although some UHF television channels are still used for traditional (NTSC) television broadcasts and others are now being used for HDTV broadcasts and even wireless microphones for local sporting events, there are generally many vacant UHF television channels in any given service area. Since the UHF television channels are already allocated by the FCC, it is anticipated that UHF-based cellular television systems could be established quickly and with little, if any, FCC approval processes.

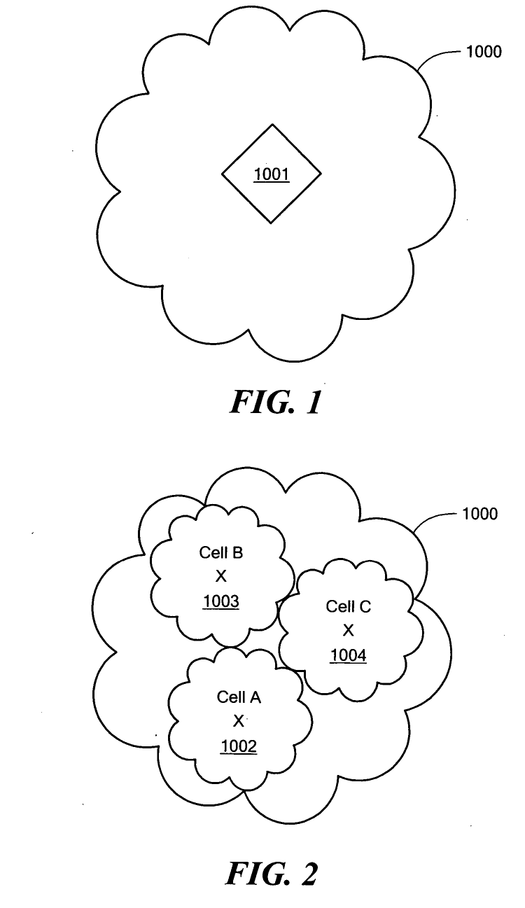

FIG. 1 is a schematic diagram showing a representation of the coverage area of a television system operating with a single television channel as known in the art. The transmitting facility 1001 operates on a designated television channel at a designated power level, and has an effective coverage area 1000 within which receiver units (such as television sets) can receive a particular program or service.

FIG. 2 is a schematic diagram showing a representation of the coverage area of a cellular television system in accordance with an exemplary embodiment of the present invention. In this example, the cellular television system includes three cells, namely Cell A 1002, Cell B 1003, and Cell C 1004. The cells can be arranged or otherwise configured to have an effective coverage area substantially equal to an existing single-channel broadcast television system 1000 (e.g., an existing television broadcaster having a license to operate within a specified coverage area might convert to a cellular television system that is constrained to operate within that coverage area), or the cells can be arranged or otherwise configured in any way permitted by available airspace.

Segmenting the coverage area into a plurality of cells effectively increases the traffic capacity of the system. For example, a system operating with a single NTSC television channel has an aggregate bandwidth of 6 MHz, whereas a cellular system having N cells (with a single television channel each) has an aggregate bandwidth of N×6 MHz. Furthermore, the system is readily expandable/scalable, for example, by adding more transmitters to meet additional bandwidth requirements. Additional advantages can be realized with such a cellular system, including the use of lower power transmitters, which are generally less expensive to own and operate and which generally cause less electromagnetic interference compared to high-power transmitters.

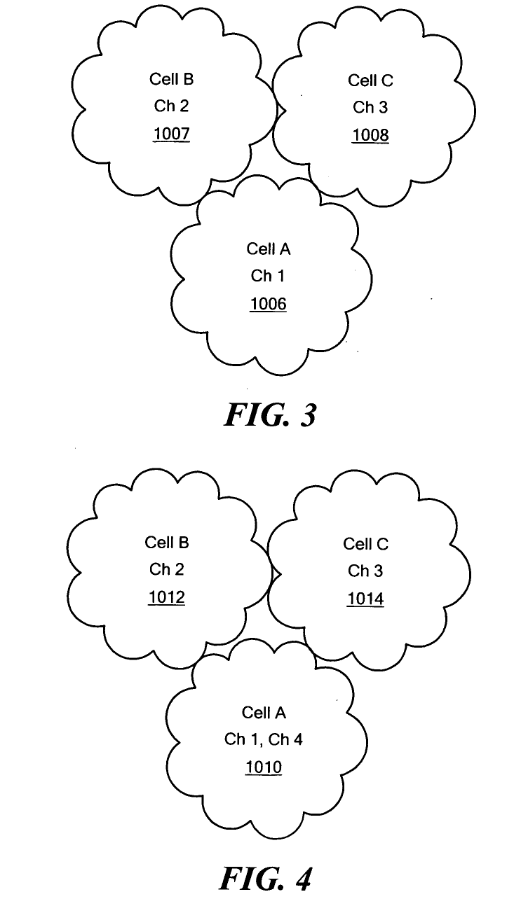

Television channels can be assigned to cells in a variety of ways, and the present invention is not limited to any particular channel assignment scheme. FIG. 3 is a schematic diagram showing a representation of a cellular television system in which adjacent cells utilize different television channels, in accordance with an exemplary embodiment of the present invention. In this example, the cellular television system includes three cells, namely Cell A 1006, Cell B 1007, and Cell C 1008. Cell A 1006 is configured to operate on a first distinct television channel (Ch1), Cell B 1007 is configured to operate on a second distinct television channel (Ch2), and Cell C 1008 is configured to operate on a third distinct television channel (Ch3).

Although additional bandwidth can be provided by adding transmitting facilities, additional bandwidth can also be provided using multiple television channels in one or more cells. For example, a second television channel may be assigned to a single cell or to multiple cells, or a separate television channel may overlay a region or the entire coverage area. Additional television channels may be allocated statically or dynamically to meet bandwidth/service requirements.

Thus, service information may be delivered to the receiver units via multiple television channels. In some cases, duplicate information may be carried over different television channels. A segment identifier or other mechanism may be used to facilitate detection of duplicate information. For example, if duplicate MPEG2-TS data is transmitted over multiple television channels, the packet identifiers of MPEG2 packets received over different television channels may be compared to detect duplicate information.

The following describes several methods by which the frequencies may be allocated and assumes that four television channels (Ch1, Ch2, Ch3, Ch4) are available to the system.

FIG. 4 is a schematic diagram showing a representation of a cellular television system using a second television channel in one cell, in accordance with an exemplary embodiment of the present invention. In this example, the cellular television system includes three cells, namely Cell A 1010, Cell B 1012, and Cell C 1014. Cell A 1010 is configured to operate on television channels Ch1 and Ch4, Cell B 1012 is configured to operate on television channel Ch2, and Cell C 1014 is configured to operate on television channel Ch3.

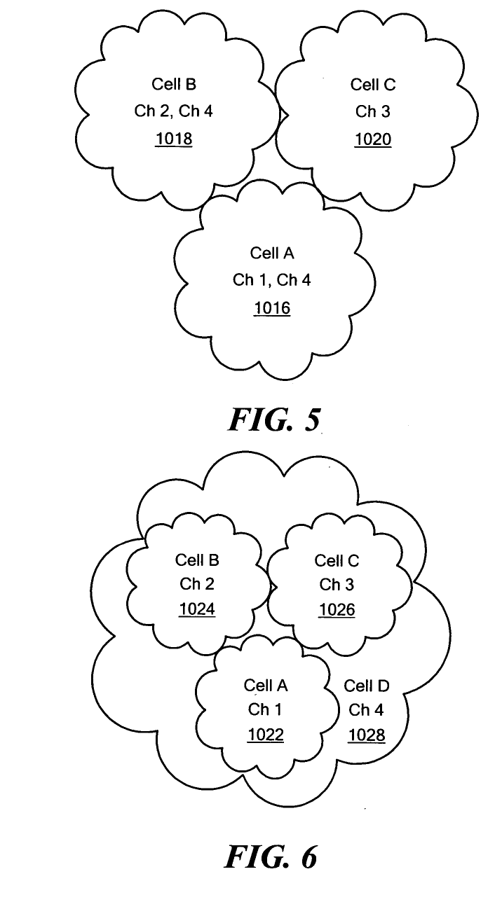

FIG. 5 is a schematic diagram showing a representation of a cellular television system using a second television channel in two adjacent cells, in accordance with an exemplary embodiment of the present invention. In this example, the cellular television system includes three cells, namely Cell A 1016, Cell B 1018, and Cell C 1020. Cell A 1016 is configured to operate on television channels Ch1 and Ch4, Cell B 1018 is configured to operate on television channels Ch2 and Ch4, and Cell C 1020 is configured to operate on television channel Ch3. In some embodiments, Ch4 may be assigned to another group of cells as long as interference to Cell1 and Cell2 is negligible. Ch4 can be assigned to all the cells if some contents are broadcasted to all the end-users in the system.

FIG. 6 is a schematic diagram showing a representation of a cellular television system using a separate television channel overlaying the entire coverage area, in accordance with an exemplary embodiment of the present invention. In this example, the cellular television system includes four cells, namely Cell A 1022, Cell B 1024, and Cell C 1026, and Cell D 1028. Cell A 1022 is configured to operate on television channel Ch1, Cell B 1024 is configured to operate on television channel Ch2, Cell C 1026 is configured to operate on television channel Ch3, and Cell D 1028 is configured to operate on television channel Ch4 in such a way that the coverage area of Cell D 1028 overlays the coverage areas of Cells A, B, and C.

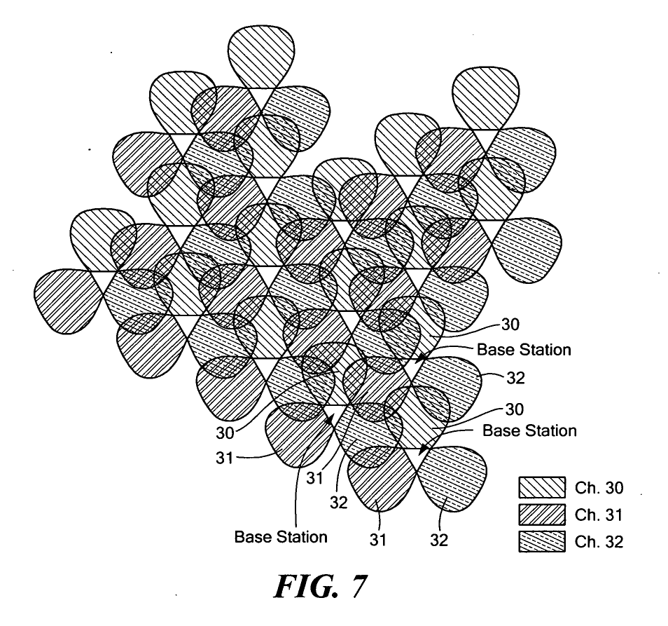

FIG. 7 is a schematic diagram showing a representation of a cellular television system utilizing three television channels in order to prevent overlap between adjacent cells, in accordance with an exemplary embodiment of the present invention. In this example, each base station includes three transmitting facilities forming three cells operating on three distinct channels, namely Ch30, Ch31, and Ch32. The cells are arranged so that no two adjacent cells operate on the same channel.

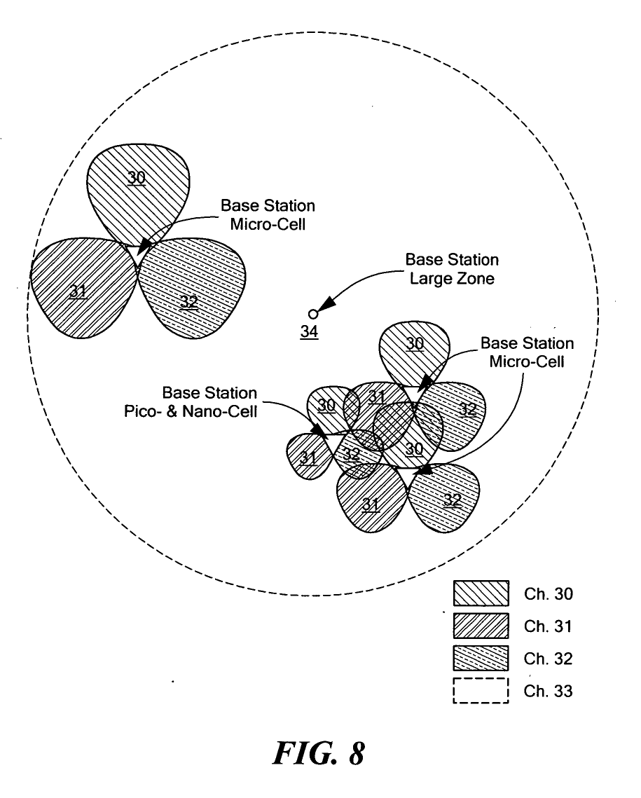

FIG. 8 is a schematic diagram showing a representation of a cellular television system having different size cells, in accordance with an exemplary embodiment of the present invention. In this example, the system includes a large cell and a number of smaller cells designated as micro-cells, pico-cells, and nano-cells to imply the relative sizes of the smaller cells. The base stations of each of the smaller cells include three transmitting facilities forming three cells operating on three distinct channels, namely Ch30, Ch31, and Ch32. The cells are arranged so that no two adjacent cells operate on the same channel. The base station of the large zone includes a transmitting facility forming a large cell operating on a distinct fourth channel, namely Ch33. The coverage area of the large cell encompasses the coverage areas of the smaller cells.

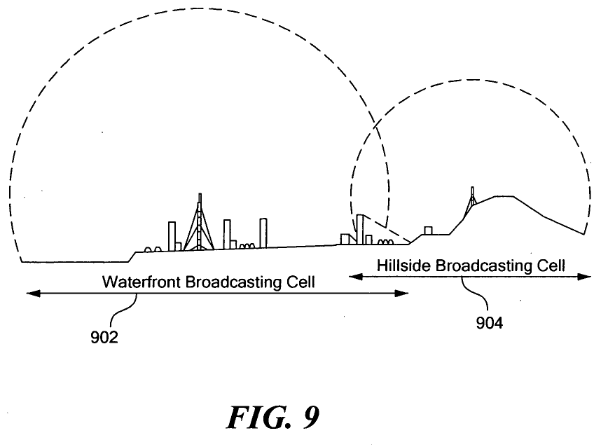

FIG. 9 is a schematic diagram showing a representation of a cellular television system including geographically defined cells, in accordance with an exemplary embodiment of the present invention. In this example, the system includes a waterfront broadcasting cell 902 and a hillside broadcasting cell 904. Such segmentation by geography may be useful, for example, in providing relevant localized information for each type of geographical region. For example, local information such as tide schedules, flood warnings, and shark sightings may be transmitted in the waterfront broadcasting cell 902, where such information may not be particularly useful for users located in the hillside broadcasting cell 904. If a particular user is traveling, say, from a home in the hillside region to a beach in the waterfront region, the user would be able to receive the waterfront information upon entering the waterfront broadcasting cell 902.

It should be noted that adjacent cells can operate on the same television channel(s). In such embodiments, interference between adjacent cells can be reduced or eliminated by transmitting each channel differently so as to form geographically different cell boundaries among different channels. For example, assuming that three adjacent cells operate on the same television channels Ch1, Ch2, and Ch3, each channel can be transmitted differently in each cell (e.g., by placement/orientation of transmitter) in order to tailor the coverage area of each television channel so as to reduce or eliminate interference.

Specific embodiments of the present invention are designed to permit one-way broadcast operation (i.e., from the service provider to the users), although optional return is paths (i.e., from the users to the service provider) can be supported, for example, to provide enhanced services, such as interactive and on-demand services. In order to permit one-way broadcast operation, each cell typically broadcasts, among other things, mapping information including at least adjacent cell information enabling mobile receiver units to transition between cells without requiring a return communication path from the receiver units to the service provider and without requiring a complex hand-off, as is typically required in cellular telephone systems. The mapping information may also include information about the current cell (such as information regarding topology, power, coverage, CTR location, offset, shape, utilization) as well as information regarding the service information (such as contents identifiers and stream identifiers).

The cells generally operate independently of one another and therefore can optionally convey different content in different cells (e.g., including local and regional content), although operation of the cells is generally coordinated in order to provide a particular information service across multiple cells (i.e., a user can generally continue to receive the same service when moving from cell to cell). Thus, the system typically includes one or more content servers in communication with the transmitting facilities. A single content server can provide information for multiple cells (including local content for each of a number of cells), or separate content servers can be used to provide some or all of the content for individual cells. Some examples of local content include local traffic information, local weather information, local navigation information, local news, information about local businesses and attractions, and coupons/advertisements for local businesses and attractions, to name but a few. Regional content may include similar types of information relating to a region or a number of cells. Global content may include similar types of information relating to the entire coverage area, and may be used particularly to provide information that is relevant to all users in the coverage area (e.g., emergency notifications and information, world/national news, alerts such as so-called “Amber” alerts, and all-point bulletins, to name but a few). The characterization of any particular type of content as local, regional, or global is arbitrary and may be different for different service providers. Some exemplary information services are discussed below.

As discussed above, information may be unicast to individual users. In other words, the representation of the program contents (e.g., station channel or TV program) may appear the same to the user while the receiver roams from cell to cell. Therefore, each receiver unit may be associated with an address (such as an IP address) that is typically unique within the system. Addresses may be assigned statically or dynamically. The service provider may maintain a distribution table or other mechanism for mapping particular services or content to specific users or groups of users (including services or content to be broadcast to all users) and/or to specific cells. The distribution table may include additional information such as, for example, time of broadcast, end user location, broadcast frequency band, and the like.

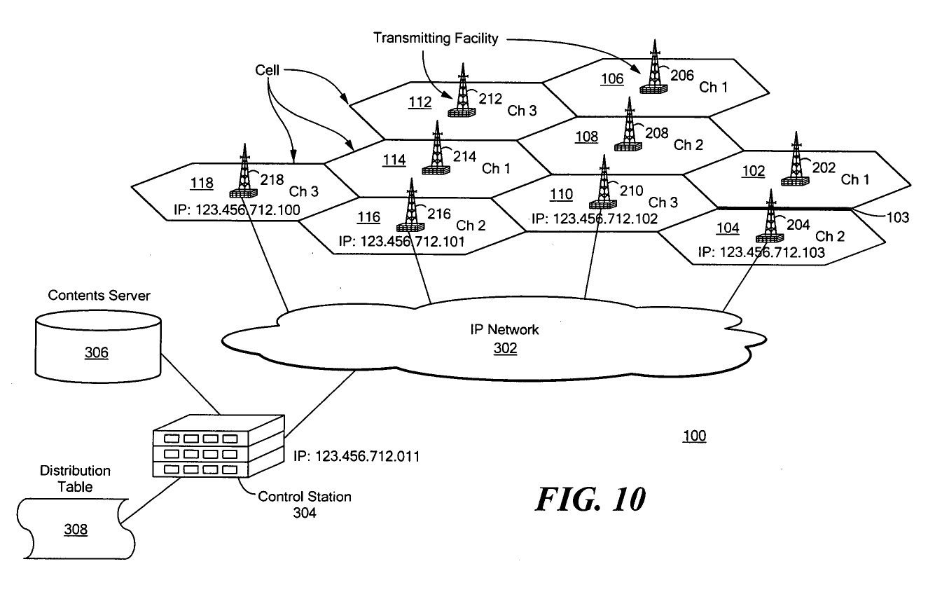

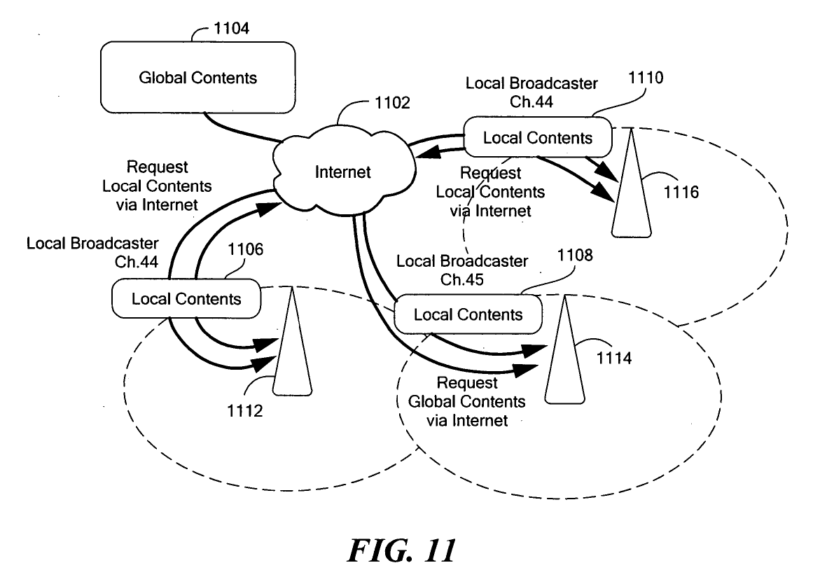

FIG. 10 is a schematic diagram showing a representation of a cellular television system 100 capable of delivering specific programming to different cells, in accordance with an exemplary embodiment of the present invention. The system 100 includes a plurality of cells 102, 104, 106, 108, 110, 112, 114, 116, and 118. Each cell typically includes a transmitting facility, although this is not required. The transmitting facility in each cell is shown as a tower and has a reference numeral that that corresponds to the cell in which it is located except that the reference numeral begins with a 2 rather than a 1. That is, for example, the transmitting facility in cell 102 has reference numeral 202, the transmitting facility in cell 104 has reference numeral 204, etc.

In FIG. 10, each cell is represented by a hexagonal coverage area. Thus, each cell may be surrounded by up to six other cells. In certain embodiments of the present invention, no adjacent cells include transmitting facilities which operate on the same television channel. Thus, for example, if a particular cell operates on television channel Ch1, then no adjacent cell would operate on television channel Ch1.

The segmentation shown in FIG. 10 may allow, for example, the service provider to broadcast localized contents to an intended area. Since the traffic is kept locally, such application further increases the frequency efficiency. Examples of local traffic are advertisement from local stores and community announcements, etc. The geographical definition of the locality is flexible and editable since a subset of cells describes the locality.

In FIG. 10, for example, identical contents may be broadcasted to only two cells, e.g., 104 and 110 by selecting the transmitting facilities 204 and 210, respectively, associated with those particular cells. Each of the transmitting facilities is typically capable of transmitting multimedia content to end-users located within a cell. In some embodiments, the content is television.

In some embodiments of the present invention, the transmitting facility associated with each cell-may be given a unique internet protocol (IP) address. For example, and as shown in FIG. 10, transmitting station 218 may be assigned IP address 123.456.712.100, transmitting station 216 may be assigned IP address transmitting 123.456.712.101, transmitting station 210 may be assigned IP address 123.456.712.102, and transmitting station 218 may be assigned IP address 123.456.712.103. In embodiments where each (or at least more than one) transmitting facility is assigned an IP address, some or all of the transmitting facilities may be connected to an IP network 302.

In addition to the various cellular television system components described above, a cellular television system, such as the system shown in FIG. 10, may include additional components, such as, for example, a control station 304, a contents server 306, and an IP network 302. In some embodiments, the IP network may be the Internet or any other public or private network. The IP network may operate as an OSI Layer-3 Network layer.

In the embodiment of FIG. 10, the control station 304 is the control center for the entire cellular television system and may include the contents server 306 and the distribution table 308. The contents server 306 may be any server capable of distributing contents to an appropriate transmitting facility. In some embodiments, the contents server 306 may be any server that may access the Internet. In some embodiments, the contents server 306 may also have access to a distribution table 308. The distribution table 308 may be used to determine which users or cells have selected (or have been assigned) specific content or service. As discussed above, the distribution table 308 may include additional information such as, for example, time of broadcast, end user location, broadcast frequency band, and the like.

It should be understood that the contents server 306 may or may not be located in the control station 304 and may actually be controlled by another service operator. Typically, as long as there is a business agreement, and appropriate supervision, contents from any number of service operators can be broadcasted directly from one operator's server.

In some embodiments of the present invention, the system may also include monitoring receivers. These monitoring receivers may be located at a transmitting facility or at a possible cell edge (for example, the edge between cells 102 and 104 denoted as bold line 103). In addition, the monitoring receivers may be located at an end-users receiver (such as the end-users television or computer) or any other appropriate location. The monitoring receivers monitor the level of interference for a given channel.

In some embodiments of the present invention, the system may also include a frequency assignment controller. The frequency assignment controller monitors signal strength and the level of interference by interrogating the monitoring receivers described above. The frequency assignment controller may then alter the frequency assignment of certain cells according to the level of interference and broadcast traffic demand.

In some embodiments, one or more of the transmitting facilities may also include a cache that is capable of storing contents prior to broadcast. In such systems, the information is transferred to the cache before the time for transmission and this may help alleviate congestion on the IP network 302 or at the content server 306. This may be particularly useful in systems that utilize on demand programming because there are times when demand for on-demand programs is increased and if certain programs are already stored at in the cache at the server, the demands on the IP network 302 and the content server 306 may be reduced. Retransmission of any part of the contents, or the entire contents may be done locally between the transmitting facility and the end-users. Retransmission of the contents to another user may be done locally as well.

The above description has been directed to FIG. 10. In general, the system of FIG. 10 is directed to a system that uses an IP network to distribute multimedia contents to particular transmitting facilities. One use of the system is to deliver programming to users utilizing a television set. As one of ordinary skill will readily realize, the information could be delivered to any device capable of receiving an over-the-broadcast such as, for example, a wireless telephone or a computer.

As discussed above, separate content servers can be used to provide some or all of the content for individual cells. Thus, for example, a global content server can be used to provide global information to all cells, and separate local content servers can be used to provide local content to respective cells. FIG. 11 is a schematic diagram showing a representation of a system having a global content server and a plurality of local content servers, in accordance with an exemplary embodiment of the present invention. The system includes three transmitting facilities 1112, 1114, and 1116. Global content is provided to the transmitting facilities from global content server 1104 over network 1102. Local content is provided to each of the transmitting facilities from a local content server. Specifically, local content is provided to transmitting facility 1112 from local content server 1106, local content is provided to transmitting facility 1114 from local content server 1108, and local content is provided to transmitting facility 1116 from local content server 1110.

In order to support local/regional content delivery, the content of a given cell can be logically divided into content classes (e.g., local, regional, global). For example, communications can be segmented (e.g., into slots, packets, etc.), with different segments used for different content classes. Certain segments may be used to transmit mapping information. Transmissions within a cell may utilize a predetermined pattern of segments, for example, a first number of global segments followed by a second number of regional segments followed by a third number of local segments. For example, a sequence of segments may be repeated as a series of frames. Each segment may include a class-of-service indicator, which would enable receiver units to process each segment according to its particular class of service.

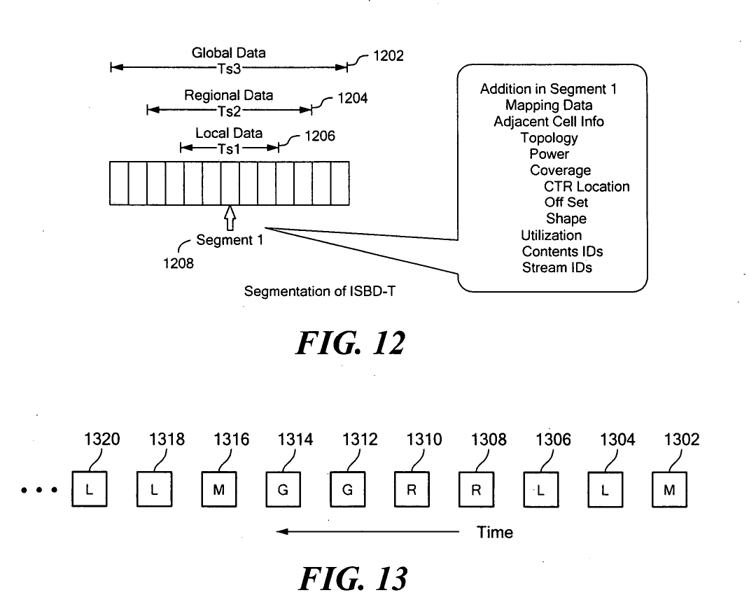

FIG. 12 is a schematic diagram showing a representation of segmented transmissions, in accordance with an exemplary embodiment of the present invention. In this example, transmissions include global data segments 1202, regional data segments 1204, and local data segments 1206. A particular segment 1208 is used to transmit mapping information.

FIG. 13 shows a sequence of transmission segments in accordance with an exemplary embodiment of the present invention. In this example, the transmitted contents may be programmed by a sequence including a mapping segment 1302 followed by two local segments 1304 and 1306, two regional segments 1308 and 1310, and two global segments 1312 and 1314. The sequence may repeat, starting with a mapping segment 1316 followed by two local segments 1318 and 1320, and so on depending on the broadcasted program sequence.

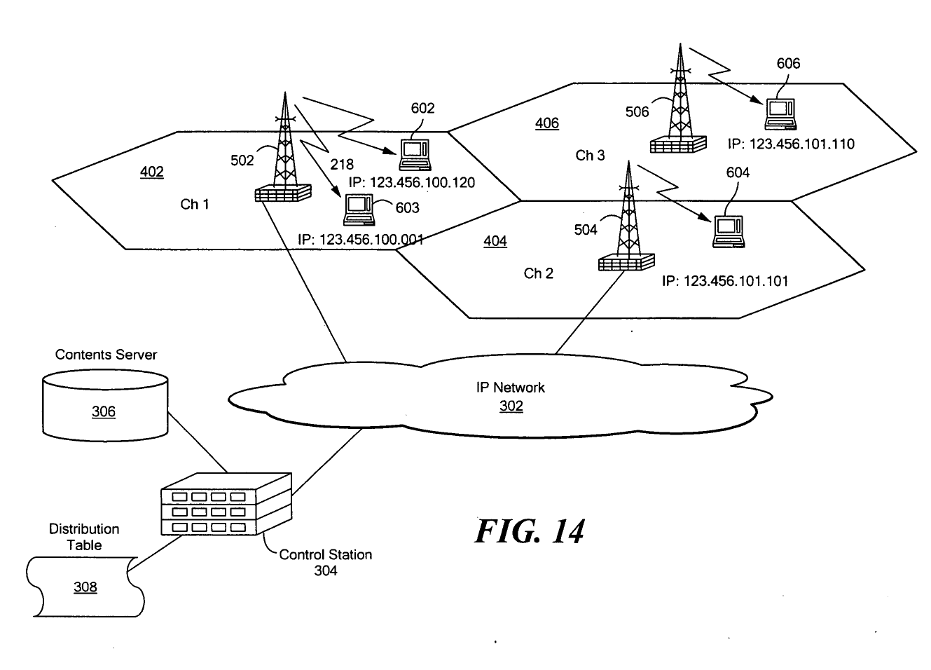

FIG. 14 is a schematic diagram showing a representation of a cellular television system in which IP packets containing multimedia contents are transmitted to the end-user over the air, in accordance with an exemplary embodiment of the present invention. In this example, it is possible, without a response from the end-user receiver, to have the transmitting facility transmit IP packets, for example, by pretending there is connectivity over the physical medium layer and the data link layer. IP packets may be transmitted as broadcast or multicast or by unicast to the end-user receiver IP address which is available prior to the transmission.

The system of FIG. 14 includes a plurality of cells 402, 404, and 406, each of which may have a transmitting facility 502, 504, and 506, respectively. In addition, this system may include a control station 304, a contents server 306, and a distribution table 308. In this example, the distribution table 308 at the control station 304 also includes over-the-air IP addresses for the end-users.

The system of FIG. 14 also includes individual end-users 602, 603, 604, and 606. Some or all of these end-users may have an individual IP address. For example, end-user 602 may have IP address 123.456.100.120, end-user 603 may have IP address 123.456.100.001, end-user 604 may have IP address 123.456.100.101, and end-user 606 may have IP address 123.456.100.110. Each end user may have a receiving device that includes the ability to be uniquely identified by an IP address. Examples include a set-top box or a computer with internet capabilities.

Furthermore, to facilitate sending contents directly to an individual end-user, some or all of the transmitting facilities may also have a router located therein. The router allows for the sending of over-the-air IP packets to a particular end-user. That is, the transmitting station broadcasts IP packets that include a particular address associated with them. These addresses, for example, could reside in the header of each IP packet that is broadcast.

Referring again to FIG. 14, the transmission station 502 could, in one embodiment, send a first packet having a header that correlates to the address of end-user 602 and a second packet having a header that correlates to the address of end-user 603. In this example, the first packet would only be received by end-user 602 and the second packet would only be received by end-user 603.

Furthermore, the transmitting facilities shown in FIG. 14 may also have the ability to perform IP tunneling or other mechanism for forward end-user IP packets through the transmitting facilities. IP tunneling encapsulates the end-users' IP address into the transport packets. In some embodiments, this may allow for communication between the contents server 306 and a particular transmitting facility.

In some embodiments, it may be necessary or desirable for the system to include some upstream connectivity from the end-user receivers to the service provider, for example, to provide acknowledgements in response to downstream messages transmitted by the service provider and/or to enable interactive or on-demand services. Various types of upstream communications can be supported. For example, the service provider may operate a separate network for upstream communications (e.g., a separate wireless network), or upstream connectivity may be provided through existing systems such as the Internet or a telephone network. Upstream communications may support IP connectivity. Upstream communications may be coordinated with downstream communications (e.g., a command/response type protocol) or may be completely independent of downstream communications (e.g., the end user may be permitted to phone in to the service provider to request a particular service). A system may support multiple types of upstream communications, and different end users may use different types of upstream communications to communicate with the service provider. Upstream communication channels are not required to correspond with cells, e.g., the service provide may utilize a single receiver facility to receive upstream communications from multiple cells.

In some embodiments, one or more auxiliary connections used for upstream communications can also be used to receive service information from the service provider. For example, the user may have an auxiliary connection in addition to the over-the-air television connection. In such cases, service information may be delivered to the receiver units via multiple connections. For example, duplicate information may be transmitted to a particular receiver unit over both an over-the-air television channel and an auxiliary connection. In some cases, duplicate information may be carried over different connections. A segment identifier or other mechanism may be used to facilitate detection of duplicate information. For example, if duplicate MPEG2-TS data is transmitted over multiple connections, the packet identifiers of MPEG2 packets received over different connections may be compared to detect duplicate information. In this way, over-the-air traffic may be diversified over the auxiliary connections. Such diversification tends to reduce the over-the-air traffic as well as increasing the security.

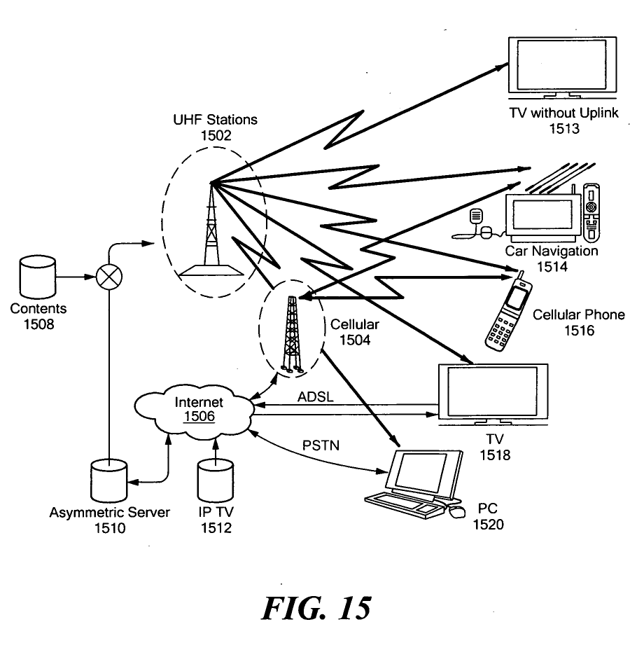

FIG. 15 is a schematic diagram showing a representation of a cellular television system with various types of upstream communications, in accordance with an exemplary embodiment of the present invention. In this example, the system includes UHF transmitting facilities 1502 and 1504 that transmit information from content server 1508 and asymmetric server 1510 to end users 1513, 1514, 1516, 1518, and 1520, which are, respectively, a television without uplink, a car navigation system, a cellular telephone, a television with uplink, and a portable computer. The information may include IP television from IP TV server 1512 provided to asymmetric server 1510 over Internet 1506. The asymmetric server 1510 may also receive upstream communications from the various end users, for example, via cellular telephone from car navigation system 1514 and cellular telephone 1516, via ADSL from home television 1518, and via the public switched telephone network (PSTN) from portable computer 1520. The types of upstream communications depicted in FIG. 15 are examples only, and it will be apparent that other types of upstream communications may be supported (e.g., data-over-cable, WIFI, FTTH, etc.).

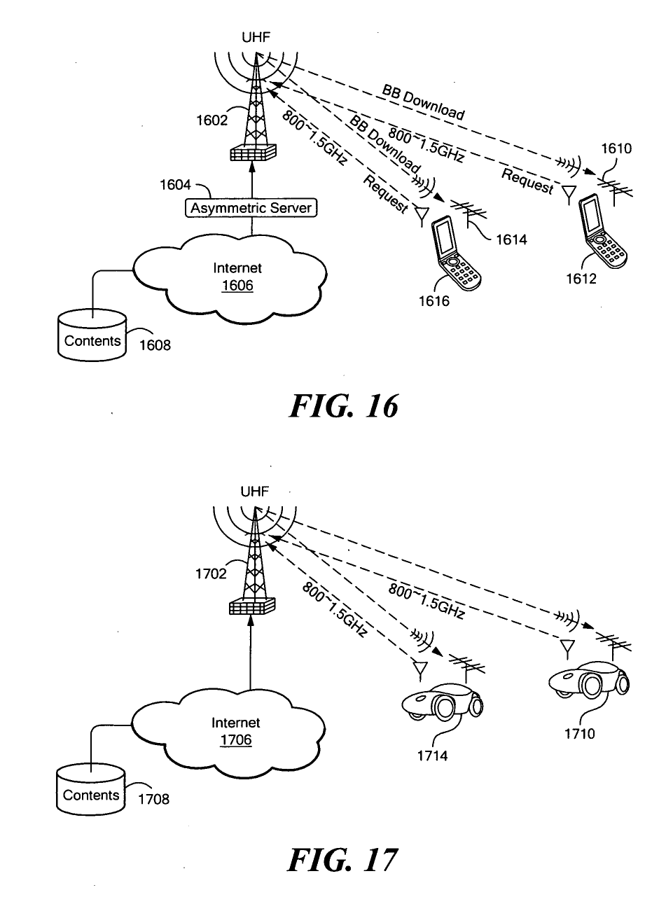

FIG. 16 is a schematic diagram showing a representation of a cellular television system with cellular upstream communications, in accordance with an exemplary embodiment of the present invention. In this example, a UHF transmitting facility 1602 transmit information from asymmetric server 1604 to end users 1610 and 1614. The information may be provided to the asymmetric server 1604 from content server 1608 over the Internet 1606. The end users may use their respective cellular telephones 1612 and 1616 to request specific services.

FIG. 17 is a schematic diagram showing a representation of a cellular television system for mobile communications such as navigation, in accordance with an exemplary embodiment of the present invention. In this example, a UHF transmitting facility 1702 transmits information to mobile stations installed or otherwise placed in automobiles 1710 and 1714. The information may be provided to the UHF transmitting facility from content server 1708 over the Internet 1706. The mobile stations may utilize wireless communications to communicate with the service provider.

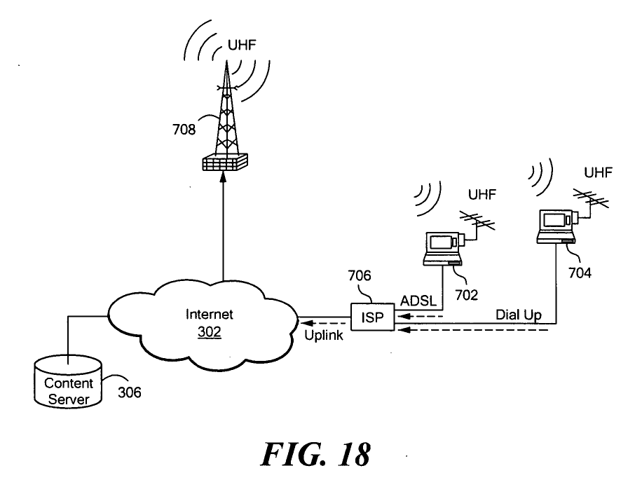

FIG. 18 is a schematic diagram showing a representation of a cellular television system including upstream communications over an auxiliary IP connection, in accordance with an exemplary embodiment of the present invention. In this example, the system may include first and second end user stations, 702 and 704 respectively. These end user stations may be connected to the IP network 302 (e.g, the Internet) through an internet service provider (ISP) 706. In this example, end user station 702 is coupled to the ISP 706 via an ADSL connection, while end user station 704 is coupled to the ISP 706 via a dial up connection. Of course, other types of connectivity (e.g., data-over-cable, wireless) are possible, and the present invention is not limited to any particular type of upstream connectivity. The upstream connections to the internet allow the end user stations 702 and 704 to communicate with the contents server 306, e.g., for interactive or on-demand services.

In order to receive information services in the cellular television system, receiver units generally need to locate one or more downstream television channels on which to receive service information. Thus, each receiver unit typically includes one or more tuners and a controller. The tuners are generally capable of tuning into any of the various television channels supported by the system, under control of the controller. When the receiver unit is powered on (or at other appropriate times, such as roaming), the controller may command a tuner to tune to a particular channel and/or scan the set of channels assigned to the system in order to locate an appropriate channel on which to receive service information. The controller may measure the signal strength, interference level, bit error rate, frame (block) error rate, or other qualities of various channels to determine the appropriate channel. If an upstream communication channel is available, then downstream channel selection (both initially and during roaming) may involve a more formal hand-off between the service provider and the receiver unit via the upstream communication channel.

As discussed above, a cellular television system may include a number of transmitting facilities that are fed content by one or more content servers. The content servers may be in communication with the transmitting facilities through a network, such as the Internet. It should be noted that the service provider that operates the transmitting facilities may operate one or more of the content servers, but may alternatively or additionally obtain content from various third party servers that may be accessible over the Internet or otherwise.

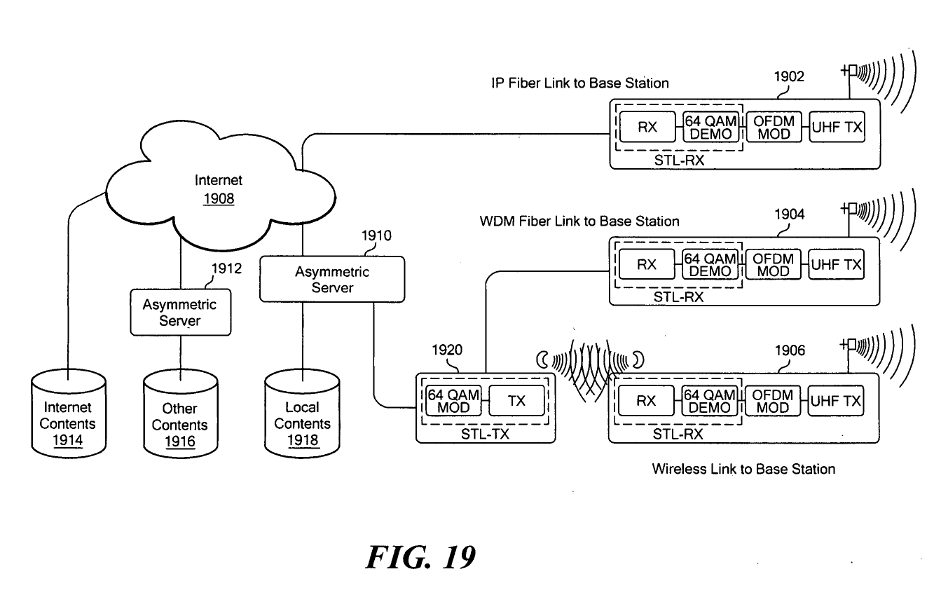

FIG. 19 is a schematic diagram showing some potential equipment configurations at service provider headend, in accordance with an exemplary embodiment of the present invention. In this example, the service provider operates three transmitters 1902, 1904, and 1906. Each transmitter includes similar components, including a receiver for receiving data from the asymmetric servers 1910 and 1912, an OFDM modulator, and a UHF transmitter. The transmitters are coupled with the remainder of the headend components over different types of communication links, from which the transmitters receive content for transmission. Specifically, transmitter 1902 is coupled over an IP fiber link, transmitter 1904 is coupled over a WDM fiber link, and transmitter 1906 is coupled over a wireless link. Content can be provided from an internet server 1914 accessible over the Internet, from local content server 1918, or from other content server 1916.

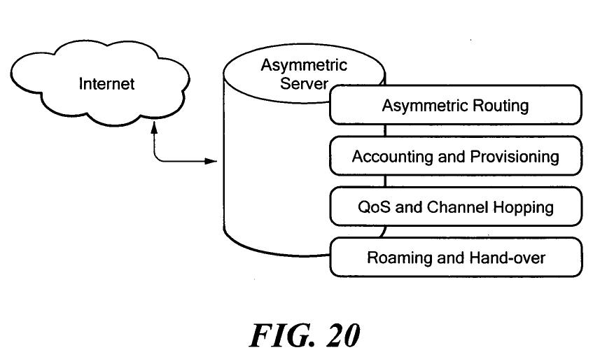

FIG. 20 is a schematic diagram showing a representation of an asymmetric server, in accordance with an embodiment of the present invention. The asymmetric server may provide such functions as asymmetric routing, accounting and provisioning, quality-of-service (QoS) and channel hopping, and roaming and hand-over.

As discussed above, the cellular television system may be implemented as a broadcast-only system (i.e., only from service provider to users) or may be implemented as a two-way system. Thus, receiver units may be implemented as receive-only devices or may be implemented with both receiver and transmitter components. Furthermore, receiver units may be implemented with a single television tuner or with multiple television tuners. In a single tuner implementation, the single tuner would be used for both receiving content and roaming. For example, the single tuner may alternate between an “online” state in which content is received over a current television channel and an “offline” state in which the tuner is used to sample television channels in adjacent cells (e.g., measure signal strength) to determine whether to remain on the current television channel or switch to an alternate television channel. In a multiple tuner implementation, one tuner may be used solely to receive content over a current channel, while a second, separate tuner may be used for roaming. With multiple tuners, roaming can be performed without interrupting receipt of content.

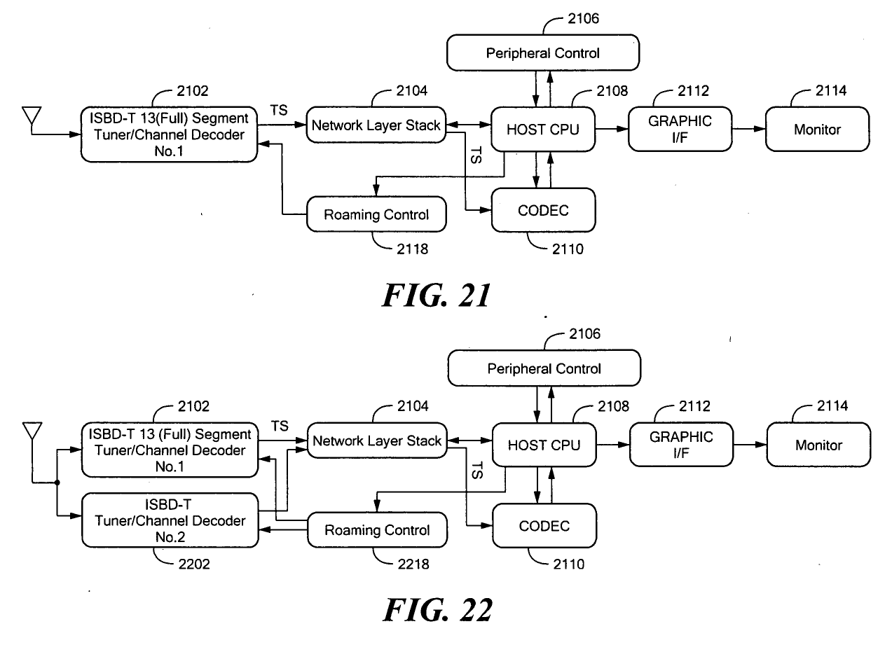

FIG. 21 is a schematic diagram showing the relevant components of a receiver unit having a single television tuner, in accordance with an exemplary embodiment of the present invention. Among other things, the receiver unit includes a tuner 2102, a network layer stack 2104, peripheral control 2106, host CPU 2108, coder/decoder (CODEC) 2110, graphic interface 2112, monitor 2114, and roaming control 2118. In this example, the single tuner 2102 is typically used for both receiving content and roaming. Therefore, the tuner 2102 may be controlled by the roaming control 2118 so as to alternate between an “online” state in which content is received over a current television channel and an “offline” state in which the tuner is used to sample television channels in adjacent cells (e.g., measure signal strength) to determine whether to remain on the current television channel or switch to an alternate television channel. The roaming controller is controlled by CPU 2108.

FIG. 22 is a schematic diagram showing the relevant components of a receiver unit having two television tuners, in accordance with an exemplary embodiment of the present invention. Among other things, the receiver unit includes a first tuner 2102, a second tuner 2202, a network layer stack 2104, peripheral control 2106, host CPU 2108, coder/decoder (CODEC) 2110, graphic interface 2112, monitor 2114, and roaming control 2118. In this example, the tuner 2102 is typically used solely for receiving content over a current television channel, while the receiver 2202 is typically used solely to sample television channels in adjacent cells to determine whether to remain on the current television channel or switch to an alternate television channel. The roaming control 2218 controls sampling by the tuner 2202 and switching channels by the tuner 2102. The roaming controller is controlled by CPU 2108. By using two tuners, sampling and switching channels can be accomplished without service interruption.

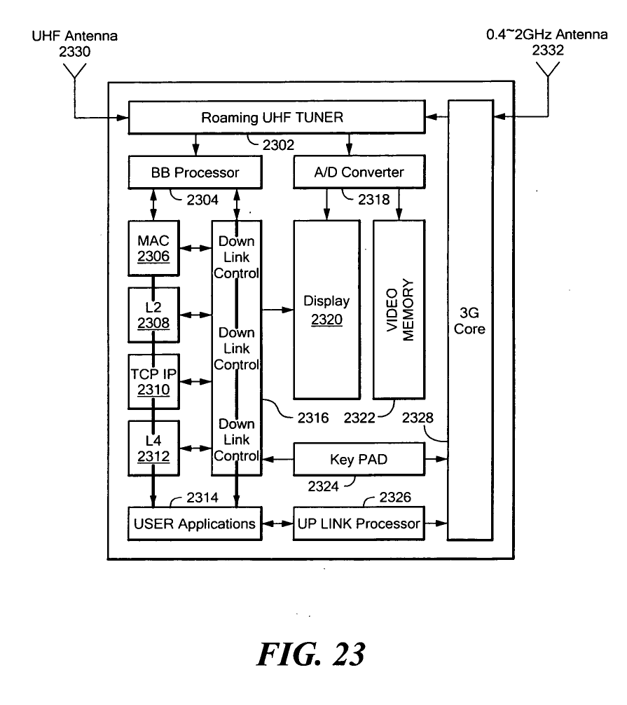

FIG. 23 is a conceptual block diagram showing the relevant components of a receiver unit including upstream communication support (e.g., a cellular telephone or other portable device with wireless transmitter), in accordance with an exemplary embodiment of the present invention. The receiver unit includes a roaming UHF tuner 2302; a broadband processor 2304; a protocol stack including MAC layer 2306, link layer (L2) 2308, IP layer 2310, transport layer (L4) 2312; user applications 2314; downlink control 2316, analog-to-digital (A/D) converter 2318; display 2320; video memory 2322; key pad 2324; uplink processor 2326; and 3G core 2328. The UHF tuner 2302 may include a single tuner or multiple tuners. The roaming UHF tuner 2302 can receive signals from both the UHF antenna 2330 and the cellular antenna 2332. Those signals are processed by the broadband processor 2304 and/or the A/D converter 2318, and may be processed through the protocol stack 2306-2312 to the user applications 2314 under control of the downlink control 2316. The user applications 2314 may generate upstream communications via uplink processor 2326 and 3G core 2328. The upstream communications may include such things as protocol acknowledgments, requests for on-demand services, requests for interactive services, and information regarding qualities of the downstream broadcast television channel(s), to name but a few. At any of the various stages of processing, certain information may be stored in video memory 2322 and/or displayed on display 2320. Also, the user may interact with user applications 2314 through keypad 2324.

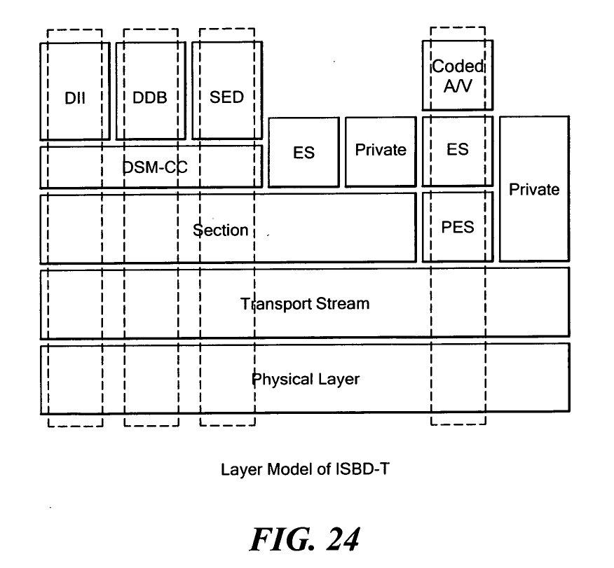

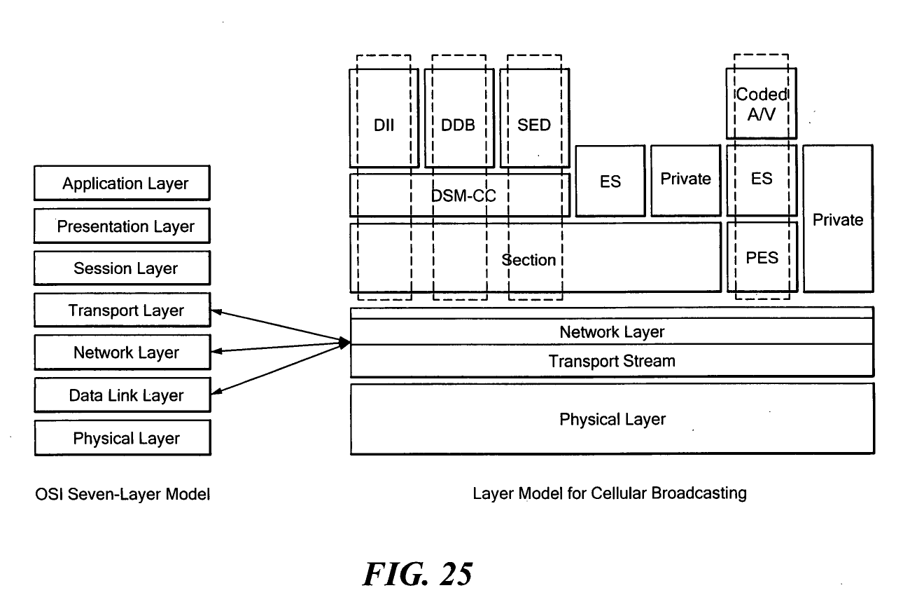

It should be noted that different embodiments of the present invention can use different cellular broadcasting protocols while remaining within the scope of the present invention, and thus the present invention is not limited to any particular protocol. FIG. 24 shows a representation of the layer model for the ISBD-T protocol as known in the art. FIG. 25 shows a representation of the layer model for a cellular broadcasting protocol in accordance with an exemplary embodiment of the present invention.

As discussed above, embodiments of the present invention can be used to provide any of a wide variety of information services, and the present invention is in no way limited to any particular information service(s). Embodiments of the present invention are also particularly useful for delivering localized information content, although the present invention is not limited to delivery of localized content. In fact, as discussed above, the same content may be transmitted across multiple cells, in which case the cellular television system can provide for continuity of service across part or all of the system, perhaps extending beyond the coverage area of a traditional broadcast television service or covering specific geographic areas that would be impossible with a traditional broadcast television service (e.g., covering suburbs around a city but not covering the city itself).

One example of an information service that can be provided using a cellular television system is real-time delivery of local navigation information, e.g., for navigation systems outfitted with cellular television support. Specifically, each cell may transmit local navigation information regarding such things as roadways, store locations, and public transportation, to name but a few. In particular, each cell may transmit detailed, up-to-date information regarding dynamic events that affect navigation within the coverage area of the cell, including such things as road closings, detours, accidents, construction, and traffic conditions, to name but a few Such dynamic events may be transitory, may change frequently, and are generally of interest only to users in or around the particular area affected.

Another example of an information service that can be provided using a cellular television system is targeted advertising. Specifically, each cell may transmit localized advertising information, e.g., to cell phones, PDAs, portable computers, or other devices outfitted with cellular television support. The localized advertising may include such things as incentives, offers, coupons, and discounts for local businesses. Because users may be transitorily within a particular cell, advertisements could be time limited (e.g., anyone who visits business X within the next 15 minutes and presents an advertised offer number gets a free gift). An exemplary business model for such a cellular television system might include the sale of advertising slots in individual cells. In this way, local businesses could advertise in a limited area within which they operate (and within which any users receiving the advertisements will necessarily be located, making it more likely that those users would visit those businesses), and therefore might be more inclined to spend money on advertising compared to advertising in a traditional television broadcast system (which might be more expensive due to the larger coverage area but with less success because the advertisements reach many users who are not in the immediate area of the business). In such a business model, the set of advertisements received by a particular user would typically change as the user moves from one cell to another.

Yet another example of an information service that can be provided using a cellular television system is uninterrupted television service across cells. Currently, many television broadcasting companies operate transmitting facilities in different cities that transmit essentially the same programs on different channels. For example, the American Broadcasting Company operates Channel 5 in the Boston, Mass. area and operates Channel 6 in the Providence, R.I. area, and the coverage areas of these channels are not only adjacent to one another, but partially overlap such that users in certain areas can receive both channels. Such television services are not “cellular” within the present context, however, because, among other things, the transmitting facilities do not transmit mapping information that would enable mobile receiver units to transition between cells in order to maintain service. In exemplary embodiments of the present invention, mapping information would be transmitted along with the television program in each cell so that receiver units (e.g., television sets with cellular television support) could automatically switch from one channel in one cell to a related channel in another cell in order to provide essentially uninterrupted viewing of a television program across cells.

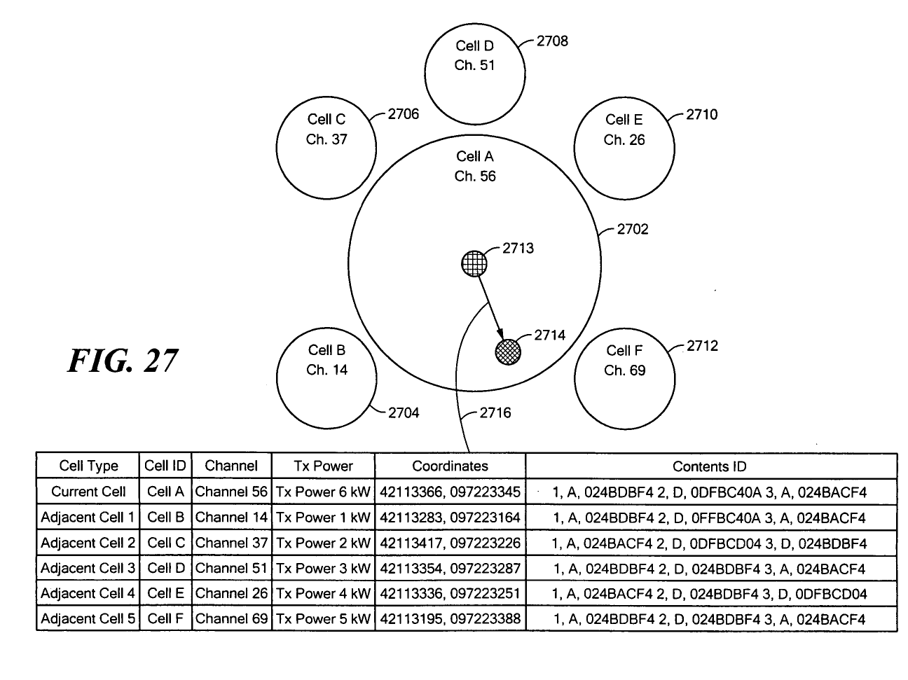

FIG. 27 is a schematic diagram showing a representation of a cellular television system transmitting mapping information, in accordance with an exemplary embodiment of the present invention. In this example, the cellular television system includes six cells, namely Cell A 2702, Cell B 2704, Cell C 2706, Cell D 2708, Cell E 2710, and Cell F 2712. The cells operate on UHF television channels 56, 14, 37, 51, 26, and 69, respectively. As discussed above, each cell transmits mapping information including adjacent cell information and optionally including additional information, such as information about the current cell (such as information regarding topology, power, coverage, CTR location, offset, shape, utilization) as well as information regarding the service information (such as contents identifiers, transport stream (TS) identifiers, and stream types). For example, transmitter 2713 in Cell A 2702 may transmit mapping information 2716 as follows:

| Cell Type | Cell ID | Channel | Tx Power | Coordinates | Contents ID |
|---|---|---|---|---|---|
| Current | Cell A | Channel | Tx Power | X, Y, Z | TS, TYPE, |
| Cell | | 56 | 6 kW | | CONTENTS |
| Adjacent | Cell B | Channel | Tx Power | | |
| Cell 1 | | 14 | 1 kW | | |
| Adjacent | Cell C | Channel | Tx Power | | |
| Cell 2 | | 37 | 2 kW | | |
| Adjacent | Cell D | Channel | Tx Power | | |
| Cell 3 | | 51 | 3 kW | | |
| Adjacent | Cell E | Channel | Tx Power | | |
| Cell 4 | | 26 | 4 kW | | |
| Adjacent | Cell F | Channel | Tx Power | | |
| Cell 5 | | 69 | 5 kW | | |

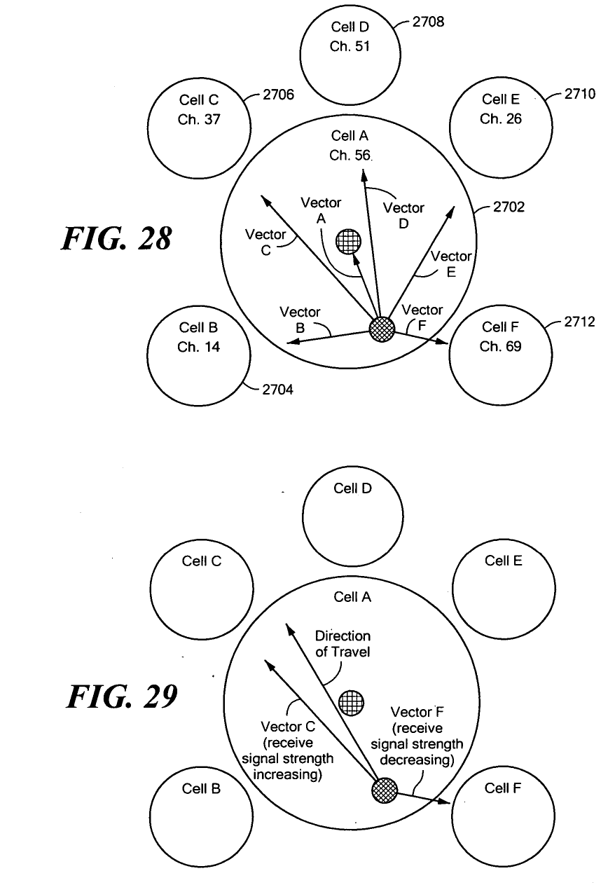

The mapping information 2716 may also include coordinates and/or contents identifiers associated with adjacent cells. A mobile receiver unit 2714 in Cell A can use the mapping information 2716 to identify attributes of the various cells, such as the channels associated with adjacent cells. The mobile receiver unit 2714 may periodically test some or all of the adjacent cell channels, as indicated in the mapping information 2716, and evaluate the quality of each adjacent cell channel relative to the quality of the channel in the current cell and/or relative to the qualities of other adjacent cell channels. For example, the mobile receiver unit 2714 may generate a vector for each cell, as shown in FIG. 28. The vectors could be based solely on a single parameter (e.g., receive signal strength) or could be based on multiple parameters (e.g., receive signal strength, transmit power, direction, etc.). The mobile receiver unit 2714 may use channel analysis for such things as making roaming decisions, estimating its location within the current cell, and estimating direction of travel, to name but a few.

For example, the mobile receiver unit 2714 might determine, based on the channel analysis, that it is closest to one particular adjacent cell (say, adjacent Cell F 2712), for example, based on receive signal strength measurements of the adjacent cell channels. The mobile receiver unit 2714 might therefore conclude that it is located in the portion of the current cell nearest that adjacent cell (in this case, the southeast portion of Cell A 2702, which is nearest Cell F 2712).

The mobile receiver unit 2714 may also determine, based on the channel analysis, that it is moving away from a first adjacent cell (e.g., the receive signal strength associated with the first adjacent cell channel, say, Ch. 69 associated with adjacent Cell F 2712, is becoming weaker over some period of time) and is moving toward a second adjacent cell (e.g., the receive signal strength associated with the second adjacent cell channel, say, Ch. 37 associated with adjacent Cell C 2706, is becoming stronger over some period of time), as shown in FIG. 29. The mobile receiver unit 2714 might therefore conclude that it is moving in the direction from the first adjacent cell toward the second adjacent cell (in this case, in a northwest direction from Cell F 2712 toward Cell C 2706).

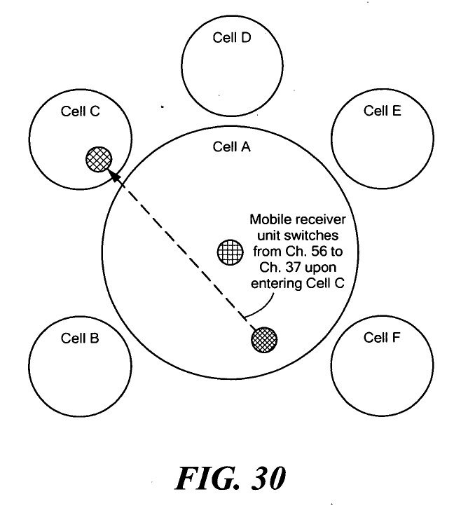

At some point, the mobile receiver unit 2714 might determine, based on the channel analysis, that it has “roamed” from the current cell to an adjacent cell (e.g., the receive signal strength of the adjacent cell channel, say, Ch. 37 associated with Cell C 2706, is greater than the receive signal strength of the channel in the current cell, which in this example is Ch. 56 associated with Cell A 2702), as shown in FIG. 30. In this case, the mobile receiver unit 2714 generally transitions to the channel operating in the adjacent cell (in this case, Ch. 37 associated with Cell C 2706) so as to begin receiving content and mapping information from the new cell. For example, the transmitter in Cell C 2706 may transmit mapping information as follows:

| Cell Type | Cell ID | Channel | Tx Power | Coordinates |
|---|---|---|---|---|
| Current Cell | Cell C | Channel 37 | Tx Power 2 kW | X, Y, Z |
| Adjacent Cell 1 | Cell A | Channel 56 | Tx Power 6 kW | |
| Adjacent Cell 2 | Cell B | Channel 14 | Tx Power 1 kW | |
| Adjacent Cell 3 | Cell D | Channel 51 | Tx Power 3 kW | |
| . | . | . | . | |
| . | . | . | . | |
| . | . | . | . | |

The mapping information may include coordinates and/or contents identifiers for one or more of the various cells. Thus, channel analysis can be used as a form of positioning system by which the mobile receiver unit can roam from cell to cell, estimate its position within the cellular television system, and estimate its direction of travel within the cellular television system. Furthermore, the mobile receiver unit can transmit positioning information back to the service provider. The service provider can use the received positioning information for such things as real-time tracking of the mobile receiver unit, locating the mobile receiver unit (e.g., in an emergency situation), and providing location-specific content to the mobile receiver unit, to name but a few. The service provider can route the contents to the destination cell before the roaming receiver starts downloading the contents from the destination cell.

The mobile receiver may correlate channel measurements (e.g., receive signal strength) with direction or positioning information (e.g., GPS information). Such correlations can provide additional information from which the mobile receiver can make roaming decisions.

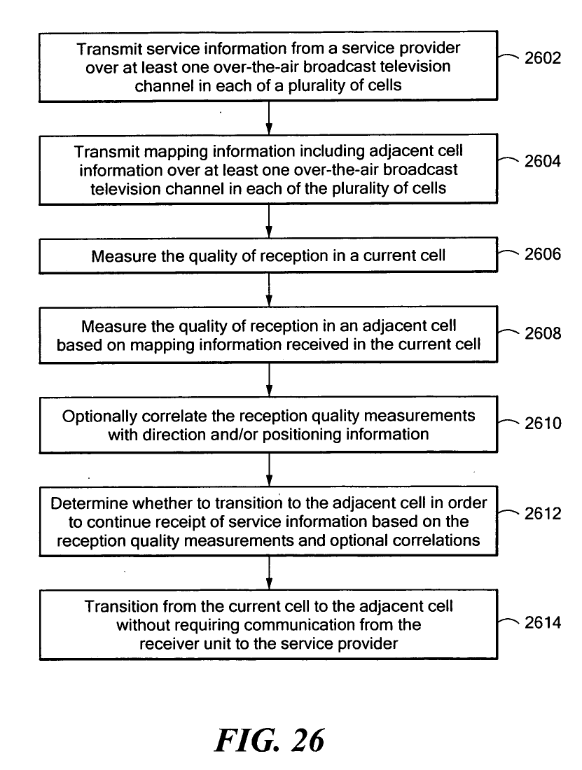

FIG. 26 is a logic flow diagram describing a method for providing information services in a cellular television system, in accordance with an exemplary embodiment of the present invention. In block 2602, service information from a service provider is transmitted over at least one over-the-air broadcast television channel in each of a plurality of cells. In block 2604, mapping information including adjacent cell information is transmitted over the at least one over-the-air broadcast television channel in each of the plurality of cells. In block 2606, the quality of reception in a current cell is measured. In block the quality of reception in an adjacent cell is measured, based on mapping information received in the current cell. In block 2610, the reception quality measurements are optionally correlated with direction and/or positioning information (e.g., based on channel analysis or GPS information). In block 2612, a determination is made whether to transition to the adjacent cell in order to continue receipt of service information based on the reception quality measurements and optional correlations. If the determination is made to transition to the adjacent cell, then, in block 2614, the transition is made from the current cell to the adjacent cell without requiring communication from the receiver unit to the service provider.

It should be noted that the coordinates included in the mapping information can include absolute coordinates (e.g., longitude/latitude or GPS coordinates) or relative coordinates (e.g., Cell B 2704 is southwest of Cell A 2702).

It should also be noted that, while exemplary embodiments are described above with reference to content servers and transmitting facilities that are coupled over layer 3 networks (e.g., IP networks), the present invention is in no way limited to layer 3 networks. For example, the at least one content server and the transmitting facilities may be coupled over a layer 2 network.

It should also be noted that terms such as “router” and “server” are used herein to describe various communication devices that may be used in a communication system, and should not be construed to limit the present invention to any particular communication device type. Thus, a communication device may include, without limitation, a bridge, router, bridge-router (brouter), switch, node, server, computer, or other communication device.

It should also be noted that the term “packet” is used herein to describe a communication message that may be used by a communication device (e.g., created, transmitted, received, stored, or processed by the communication device) or conveyed by a communication medium, and should not be construed to limit the present invention to any particular communication message type, communication message format, or communication protocol. Thus, a communication message may include, without limitation, a frame, packet, datagram, user datagram, cell, or other type of communication message.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In a typical embodiment of the present invention, predominantly all of the feature server logic is implemented as a set of computer program instructions that is converted into a computer executable form, stored as such in a computer readable medium, and executed by a microprocessor within the feature server module under the control of an operating system.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and intemetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

The present invention may be embodied in other specific forms without departing from the true scope of the invention. The described embodiments are to be considered in all respects only as illustrative and not restrictive.

What is claimed is:

1. A cellular television broadcasting system comprising:
at least one content server for providing service information from a service provider; and
a plurality of cells, each cell including a transmitting facility in communication with at least one content server for transmitting service information and mapping information over at least one over-the-air broadcast television channel, the mapping information including adjacent cell information enabling a remote mobile receiver unit to transition from a current cell to an adjacent cell in order to continue receipt of service information without requiring communication from the receiver unit to the service provider.

2. A system according to claim 1, wherein the mapping information further includes information regarding the current cell.

3. A system according to claim 2, wherein the mapping information further includes information regarding the service information.

4. A system according to claim 1, wherein the broadcast television channels are UHF television channels.

5. A system according to claim 1, wherein two adjacent cells transmit on different television channels.

6. A system according to claim 1, wherein two adjacent cells transmit on the same television channel.

7. A system according to claim 1, wherein the service information includes multimedia information.

8. A system according to claim 1, wherein the service information includes television content.

9. A system according to claim 1, wherein the service information includes logical channel associated with defined content in the service information.

10. A system according to claim 1, wherein the at least one content server provides different content to at least two different cells.

11. A system according to claim 10, wherein the different content includes local content for each different cell.

12. A system according to claim 10, wherein the different content is logically divided into different content classes.

13. A system according to claim 12, wherein the different content classes include local content, regional content, and global content.

14. A system according to claim 12, wherein transmissions are segmented such that different segments are used for different content classes.

15. A system according to claim 14, wherein transmissions utilize a predetermined pattern of segments.

16. A system according to claim 14, wherein each segment includes a class-of-service indicator.

17. A system according to claim 1, wherein the at least one content server and the transmitting facilities are coupled over an IP network.

18. A system according to claim 1, wherein the at least one content server and the transmitting facilities are coupled over a layer 2 network.

19. A system according to claim 1, wherein each transmitting facility is assigned a unique address within the system for communication with the at least one content server.

20. A system according to claim 19, wherein the at least one content server and the transmitting facilities are coupled over an IP network, and wherein the unique addresses are IP addresses.

21. A system according to claim 1, wherein transmissions include digital information addressed to a plurality of users.

22. A system according to claim 1, wherein transmissions include digital information addressed to a single user.

23. A system according to claim 1, further comprising:
a receiving facility in communication with the at least one content server for enabling users to request specific services provided by the cellular television broadcasting system.

24. A system according to claim 23, wherein the at least one content server provides service information to a user based on a request received through the receiving facility.

25. A system according to claim 1, further comprising:
at least one monitor receiver for monitoring qualities of at least one broadcast television channel in a respective cell; and
a frequency-assignment controller in communication with the at least one monitor receiver for altering channel assignments based on the qualities.

26. A method for providing an information service in an over-the-air broadcast television system, the method comprising:
transmitting service information from a service provider over at least one over-the-air broadcast television channel in each of a plurality of cells; and
transmitting mapping information over the at least one over-the-air broadcast television channel in each of the plurality of cells, the mapping information including adjacent cell information enabling a remote mobile receiver unit to transition from a current cell to an adjacent cell in order to continue receipt of service information without requiring communication from the receiver unit to the service provider.

27. A method according to claim 26, wherein the mapping information further includes information regarding the current cell.

28. A method according to claim 27, wherein the mapping information further includes information regarding the service information.

29. A method according to claim 26, wherein the broadcast television channels are UHF television channels.

30. A method according to claim 26, wherein the current cell and the adjacent cell operate on different television channels.

31. A method according to claim 26, wherein the current cell and the adjacent cell operate on the same television channel.

32. A method according to claim 26, wherein the service information includes multimedia information.

33. A method according to claim 26, wherein the service information includes television content.

34. A method according to claim 26, wherein the service information includes different content in each of the current and adjacent cells.

35. A method according to claim 34, wherein the different content includes local content for each cell.

36. A method according to claim 34, wherein the different content is logically divided into different content classes.

37. A method according to claim 36, wherein the different content classes include local content, regional content, and global content.

38. A method according to claim 36, wherein transmissions are segmented such that different segments are used for different content classes.

39. A method according to claim 38, wherein transmissions utilize a predetermined pattern of segments.

40. A method according to claim 38, wherein each segment includes a class-of-service indicator.

41. A method according to claim 26, wherein the service information includes digital information addressed to a plurality of users.

42. A method according to claim 26, wherein the service information includes digital information addressed to a single user.

43. Apparatus for use in a cellular television broadcast system having a plurality of cells, each cell transmitting service information over at least one over-the-air broadcast television channel, the apparatus comprising:
a receiver for receiving service information and mapping information over at least one broadcast television channel within a cell, the mapping information including adjacent cell information; and
a controller operably coupled to the receiver for transitioning the receiver from at least one broadcast television channel in a current cell to at least one broadcast television channel in an adjacent cell in order to continue receipt of service information without requiring communication back to a service provider.

44. Apparatus according to claim 43, wherein controller analyzes television channels in a plurality of cells based on the mapping information and transitions the receiver based on such channel analysis.

45. Apparatus according to claim 44, wherein the receiver includes a single television tuner for receiving the service information and mapping information over the at least one broadcast television channel in the current cell and for analyzing the channels.

46. Apparatus according to claim 45, wherein the receiver includes a first state in which the service information and mapping information is received over the at least one broadcast television channel in the current cell and a second state in which the controller analyzes the channels.

47. Apparatus according to claim 44, wherein the receiver includes:
a first television tuner for receiving the service information and mapping information over the at least one broadcast television channel in the current cell; and
a second television tuner for analyzing the channels.

48. Apparatus according to claim 44, wherein such channel analysis includes measuring receive signal strength of each channel.

49. Apparatus according to claim 44, wherein the controller further generates a vector for each cell based on such channel analysis.

50. Apparatus according to claim 44, wherein the controller estimates location based on such channel analysis.

51. Apparatus according to claim 44, wherein the controller estimates direction of travel based on such channel analysis.

52. Apparatus according to claim 43, further comprising:
a transmitter operably coupled to the controller for transmitting information to the service provider.

53. Apparatus according to claim 52, wherein the transmitted information includes at least one of:
protocol acknowledgments;
requests for on-demand services;
requests for interactive services;
channel quality information; and
positioning information.
